(19) United States
(12) Patent Application Publication
(10) Pub. No.: US 2007/0028078 A1
(43) Pub. Date: Feb. 1, 2007

(54) Instruction queues in pipelined processors

(75) Inventors: Glen Andrew Harris, Austin, TX (US); Stephen John Hill, Austin, TX (US); David James Williamson, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/189,020

(22) Filed: Jul. 26, 2005

(51) Int. Cl. G06F 9/30

(52) U.S. Cl. 712/214

(57) ABSTRACT

A data processing apparatus comprising: a pipelined processor comprising an execution pipeline operable to execute instructions in a plurality of execution stages; a fetch unit for fetching instructions from a memory prior to sending those instructions to said execution pipeline; an instruction decoder operable to decode said fetched instructions; instruction evaluation logic operable to evaluate if a decoded instruction has executed as anticipated prior to said decoded instruction passing a replay boundary within said execution pipeline; a data store operable to store a plurality of decoded instructions in an instruction queue, said data processing apparatus being operable to store a decoded instruction within said instruction queue at least one cycle prior to said decoded instruction entering said execution pipeline and to remove said decoded instruction from said instruction queue upon said decoded instruction passing said replay boundary within said execution pipeline, said instruction queue being arranged such that a next decoded instruction to be read from said instruction queue for execution by said execution pipeline is indicated by a pending pointer value and an instruction being executed in a furthest occupied execution stage of said execution pipeline prior to said replay boundary is indicated by a replay pointer value; wherein in response to said instruction evaluation logic detecting that said instruction indicated by said replay pointer has not executed as anticipated, said data processing apparatus is operable: to update said pending pointer value with said replay pointer value; to flush instructions from said execution pipeline; and to resume operation such that a next instruction to be read from said instruction queue for execution by said execution pipeline is said decoded instruction indicated by said updated pending pointer value.

### BACKGROUND OF THE INVENTION

1. Field of the Invention

This invention relates to the field of data processing systems. More particularly, this invention relates to the field of instruction queues in pipelined processors.

2. Description of the Prior Art

Many data processing apparatus have instruction fetch or prefetch units to fetch instructions that are to be executed, decode units to decode the instructions and execution units to execute the instructions. In pipelined processors the execution unit takes the form of a “pipeline”, the pipeline having several execution stages, an instruction being fed into the first stage during one clock cycle and proceeding down through further execution stages during subsequent clock cycles. It has been found to be convenient in some data processors to have an instruction queue generally referred to as a pending queue. This pending queue acts to isolate the progress of the upstream decode stages from the execution stages, providing a buffer between the two and making it easier to provide instructions to the execution stage at every clock cycle even if there are delays in instruction fetch or decode. Thus, the queue provides a means of collapsing any bubbles which may occur in the instruction fetch stream and/or decode activity and stops them reaching or at least reduces their number in the execution stages.

In many pipelined processors instructions from a program sequence are fed one after the other into the pipeline where they are executed. Many of the instructions rely on data that has been updated by a previous instruction in the program sequence. Thus, if the previous instruction has not completed its load of the updated data before the subsequent instruction requires the data the subsequent instruction will not be able to execute correctly.

One way of avoiding this is to only allow an instruction to enter the pipeline when it is known that the previous instruction has successfully completed the data load/store. However, this slows down the processor considerably. An alternative, which has been found to more efficient, is to assume that a data access will be a cache access and to ensure that the subsequent instruction is only issued when it is predicted that the previous instruction would have successfully completed its cache load. This works in most cases as most instructions access data within a cache, however, in a few instances the data will not be in the cache and in such circumstances the load will take longer than predicted and thus the subsequent instruction will not be able to execute correctly.

There are several ways of dealing with this, in one of these the pipeline processor can be stalled such that the instruction that cannot complete correctly and instructions previous to it are stalled until the data is ready. The problem with this is that it is surprisingly complex to stall a processor in this way, as the stall ripples back through the execution stages of the pipeline processor and to decode and fetch, this is complicated to control and can generate bugs. It also requires additional logic which compromises cycle timing.

A less complex solution is to replay the instruction that did not execute correctly and to replay all subsequent instructions to it. One way of doing this is to have a separate replay queue. U.S. Pat. No. 5,987,594 discloses one way of replaying instructions that have not executed correctly.

A further paper which address this problem is an academic article entitled “Power-Aware Issue Queue Design for Speculative Instruction” by Tali Moreshet et al. In this article the problem of predicting the time that an instruction will take and what occurs if this prediction is incorrect is looked at. This article looks at ideas of keeping instructions that are executing in the issue queue allowing for a fast recovery path. It gives no details of how this is done and notes that this would not be a very good idea as the issue queue is on the critical path thus requiring it to be implemented using high speed circuitry. Using high speed circuitry for the issue queue would make it very power hungry. It suggests that an alternative to this would be a dual issue queue scheme in which an issue queue would consist of two parts, the main issue queue and the replay issue queue. The main issue queue would be similar to the replay issue queue the main difference being that the replay issue queue only needs to be searched after a load hit mis-prediction and it is not on the critical paths of the processor pipeline. Thus, it can be made of circuitry that is slower to access.

### SUMMARY OF THE INVENTION

A first aspect of the present invention provides a data processing apparatus comprising a pipelined processor said pipelined processor comprising an execution pipeline operable to execute instructions in a plurality of execution stages; a fetch unit for fetching instructions from a memory prior to sending those instructions to said execution pipeline; an instruction decoder operable to decode said fetched instructions; instruction evaluation logic operable to evaluate if a decoded instruction has executed as anticipated prior to said decoded instruction passing a replay boundary within said execution pipeline; a data store operable to store a plurality of decoded instructions in an instruction queue, said data processing apparatus being operable to store a decoded instruction within said instruction queue at least one cycle prior to said decoded instruction entering said execution pipeline and to remove said decoded instruction from said instruction queue upon said decoded instruction passing said replay boundary within said execution pipeline, said instruction queue being arranged such that a next decoded instruction to be read from said instruction queue for execution by said execution pipeline is indicated by a pending pointer value and an instruction being executed in a furthest occupied execution stage of said execution pipeline prior to said replay boundary is indicated by a replay pointer value; wherein in response to said instruction evaluation logic detecting that said instruction indicated by said replay pointer has not executed as anticipated, said data processing apparatus is operable to update said pending pointer value with said replay pointer value, to flush instructions from said execution pipeline and to resume operation such that a next instruction to be read from said instruction queue for execution by said execution pipeline is said decoded instruction indicated by said updated pending pointer value.

It has been found that both the problem of decoupling the fetch and decode stages from the execution stages and the problem of instructions not executing as anticipated can both be addressed by the provision of a single hybrid queue which incorporates both instructions that are pending prior to entering the execution pipeline and those that are currently executing within the pipeline and have not yet passed a replay boundary, i.e. those that would be required to be reissued in the event of a replay occurring. It should be noted that replay may occur where an instruction does not execute as anticipated. This generally is necessary where a subsequent instruction requires data that has been updated by a preceding instruction. The preceding instruction is predicted to be able to update the data in time for the subsequent instruction to use it and would generally do so if any data it needs to access is stored in a cache. However, in the case of a cache miss where the preceding instruction then needs to access memory, it may be that the data is not updated in time for the subsequent instruction and in such a case the subsequent instruction can not execute as anticipated. In such a case replay of the instruction that does not execute as anticipated is required.

The use of a single queue with replay and pending pointers indicating which instructions are to be issued from the queue for execution by the execution pipeline during normal operation and which are to be issued in the case of replay being required, provides a queue where the pointers themselves can be updated rather than the data being shifted. This is considerably more power efficient than moving the instructions themselves. It should be noted that the instructions within this queue are decoded instructions and are as such quite wide. Thus, not having to move the instructions themselves provides a significant power saving.

In some embodiments, said data processing apparatus further comprises a data store operable to store a plurality of values comprising at least two of: a total value indicating a total number of decoded instructions stored within said instruction queue, a replay value indicating a number of decoded instructions that have been read from said instruction queue for execution by said execution pipeline and have not passed said replay boundary, and a pending value indicating a number of instructions stored within said instruction queue that have yet to be read from said instruction queue for execution by said execution pipeline; wherein in response to detection of said instruction indicated by said replay pointer not executing as anticipated, said data processing apparatus is operable to update said at least two stored values, said updated values being such that said pending value and said total value comprise said total value and said replay value comprises zero

The storage of values indicating the depth of the respective portions of the queue is a convenient way of managing the queue, allowing instructions to be in effect moved between a replay portion of a queue and a pending portion without actually ever moving the data. It is simply the pointer values and the queue depth values that are updated. Given that decoded instructions are wide data values this is a very efficient way of controlling the queue without having to move large data values. It should be noted that as the total value is equal to the replay value plus the pending value only two of the values need to be stored as the third value can always be calculated from the two stored values.

In embodiments, said data processing apparatus is operable to control said fetch unit and decoder to stall and not to fetch or decode further instructions upon detection of said pending value being equal to or greater than a predetermined value, and to control said fetch unit and decoder to fetch and decode further instructions upon detection of said pending value being less than said predetermined value.

The use of a stall mechanism which stalls the fetch and decode units when the pending queue becomes too large is a standard way of controlling the pending queue. In this embodiment, it is particularly advantageous as when replay occurs the pending queue is updated, in effect encompassing both formerly-replayable and formerly-pending instructions, and thus potentially becomes very long. In such a circumstance the stall mechanism is automatically turned on and thus, no special mechanism needs to be provided to cope with stalling the apparatus in the event of replay. This is therefore an efficient way to deal with replay. It should also be noted that the stall mechanism is automatically turned off, in other words once replay is initiated the processing apparatus can proceed as it usually would without the need for additional logic to control the replay procedure.

In embodiments, said data processing apparatus further comprises a shift data store operable to store at least one decoded instruction immediately prior to said at least one decoded instruction entering said execution pipeline.

The insertion of a shift data store or queue between the hybrid pending/replay queue and the execution pipeline means that instructions can be fed to this queue either directly from upstream decode logic if the hybrid queue is empty or from the hybrid queue itself prior to them entering the execution pipeline. The shift queue is a positional queue rather than a pointer queue thus, the entries (decoded instructions) must be shifted within the structure which does cost power. However, it has the advantage that these decoded instructions are immediately available to feed the issue analysis logic, and potential delays in retrieving these instructions from the hybrid pointer queue with the use of multiplexers as read ports are removed from the critical path. As the shift queue is small only containing the instructions that are under immediate analysis for issue to the execution pipeline, the increase in power required for shifting this data is found to be more than acceptable when compared to the timing advantages that are gained by placing the shift queue into the critical issue analysis path.

In embodiments, said data processing apparatus comprises a decoder having a plurality of decode stages and is operable to load an instruction into said instruction queue from a predetermined decode stage within said decoder.

The use of a common entry point for both pending and replayable instructions into the hybrid instruction queue means that instructions enter the queue once and do not need to be physically moved within the queue, the queue being controlled by pointers and in some embodiments depth values. This has power saving implications.

In some embodiments, said data processing apparatus is operable on reading an instruction from said queue for execution by said execution pipeline to update said pointer value to indicate a subsequent instruction, to decrease said pending value by one and to increment said replay value by one.

As instructions are issued from the queue, this affects whether they should be in the pending queue or the replay portion of the queue. The fact that an instruction has been read from the queue for execution by the execution pipeline does not mean that it should disappear from the hybrid queue, rather it should transition from being classified as pending to being classified as a replay instruction, this can be seen as in effect being transferred from the pending portion of the queue to the replay portion of the queue. This can simply be done by updating the pointer value to indicate a subsequent instruction and decreasing the pending value by one and incrementing the replay value by one. Thus, the decoded instruction remains in the same place within the queue and it is simply the address values and depth values that are updated. Thus, the decoded instruction transitions from one classification to another but does not itself move.

In some embodiments, said data processing apparatus is operable when an instruction within said execution pipeline passes said replay boundary, to update said replay pointer to indicate a subsequent instruction and to decrease at least one of said replay value and said total value by one.

When an instruction passes a replay boundary it in effect exits the hybrid queue. This is not done by deleting the value from the queue; rather the replay pointer and replay value and/or total value are changed. In some cases the replay value is not itself stored, it being sufficient to store just two of the three values, thus the pending and total values may be stored. In such a case it is the total value that is decremented. This indicates to the data processing apparatus that the storage location in which the decoded instruction that has just passed the replay boundary is invalid and can be updated with a further decoded instruction.

In some embodiments in response to said pending value being zero, said data processing apparatus is operable to read an instruction for execution by said pipeline from said instruction decoder, to write said instruction to said instruction queue, and to update at least one of said replay value and said total value by incrementing it by one.

If the pending queue is empty at any time, which may occur if the execution pipeline is operating faster than the fetch unit and decode, then instructions are read directly from decode into the execution pipeline. However, although they do not need to be entered into the pending queue they do need to be entered into the replay queue. Thus, they are entered into the hybrid queue as usual, however, the replay value (and/or total value) is updated and the pending value is not changed.

In some embodiments, said instruction evaluation logic is operable to detect that said instruction indicated by said replay pointer has not executed as anticipated when said instruction is executing in an execution stage of said execution pipeline immediately prior to said replay boundary.

Generally, the instruction evaluation logic detects whether an instruction is executed as anticipated shortly before the replay boundary. This can be in the execution stage immediately before the replay boundary or in some embodiments it can be done over a couple of execution stages preceding the replay boundary.

In some embodiments, said instructions fetched from said memory are instructions from within a program sequence and said data processing apparatus is operable to read said decoded instructions from said queue for execution by said execution pipeline in an order of said program sequence.

Generally instructions that are stored within a memory and fetched to a data processing apparatus are instructions from within a program sequence. In embodiments of the invention, these are issued to the execution pipeline strictly in order of the program sequence. This is simply done by updating the pending pointer to point to subsequent instructions in the program sequence.

Although the replay boundary can be anywhere within the execution pipeline, it is generally towards the end of the execution pipeline and located between execution stages. In some embodiments, said replay boundary is located at an end of said final execution stage of said execution pipeline.

In embodiments of the invention, said pipelined processor is a multiple instruction issue pipelined processor comprising multiple parallel execution pipelines, in which a next multiple of decoded instructions to be read from said instruction queue for execution by said multiple pipelines are indicated by at least one pending pointer, and wherein said multiple parallel execution pipelines have a hierarchy, such that a first instruction to be read from said queue indicated by a first of said at least one pending pointers is issued to an older of said multiple pipelines and subsequent later instructions are issued to subsequent younger pipelines and an instruction being executed in a furthest occupied execution stage before said replay boundary and within an oldest occupied one of said execution pipelines is indicated by a first replay pointer value; wherein in response to said instruction evaluation logic detecting that one of said instructions executing in an execution stage immediately preceding said replay boundary has not executed as anticipated, said data processing apparatus is operable to update said at least one pending pointer value with a value derived from said replay pointer, said value indicating said instruction that has not executed as anticipated.

The present inventive idea can be used in embodiments of the invention where there are multiple pipelines in parallel and multiple instruction issue. Embodiments of the invention efficiently control instruction issue to the execution pipelines and replay scenarios where an instruction may not execute as anticipated.

In some embodiments, said queue comprises multiple pending pointers and multiple replay pointers, an instruction indicated by a first of said multiple pending pointers being an instruction to be read from said queue to be executed in an older of said multiple pipelines and subsequent later instructions indicated by subsequent further pending pointers are to be executed in subsequent younger pipelines; and an instruction being executed in a furthest occupied execution stage before said replay boundary and within an oldest occupied one of said execution pipelines is indicated by a first replay pointer value and subsequent later instructions are indicated by subsequent replay pointers; wherein in response to said instruction evaluation logic detecting that one of said instructions executing in an execution stage immediately preceding said replay boundary and indicated by one of said replay pointers has not executed as anticipated, said data processing apparatus is operable to update said first pending pointer value with a value of said replay pointer indicating said instruction that has not executed as anticipated and to update said subsequent pending pointers with replay pointer values of replay pointers subsequent to said replay pointer indicating said instruction that has not executed as anticipated.

In some embodiments, where there are multiple pipelines, such that more than one instruction is issued in a cycle there may be multiple pending pointers indicating next instructions to be issued. Thus, all instructions to be issued in a next cycle are indicated by a pending pointer and any instruction executing in a stage preceding the replay boundary is indicated by a replay pointer. Although in this embodiment there is a pointer for each pipeline, this is not necessary. The more pointers there are the easier it is to read the next instruction from the pipeline, but the more data that needs to be stored (one address for each pointer). If there are fewer pointers than pipelines then the processing apparatus derives the next instruction to be issued from the pointers there are and the instruction order. There needs to be at least one pending pointer and at least one replay pointer, subsequent pointers can be derived from these values.

In some embodiments, instructions executing in a same stage in parallel pipelines to said instruction indicated by said first replay pointer are indicated by subsequent replay pointers and instructions being executed in a preceding execution stage of said older pipeline and subsequent pipelines excepting said youngest pipeline are indicated by further subsequent replay pointers.

If there are multiple pipelines these are generally arranged in hierarchical order. In such a case it may be that the instruction that does not execute as anticipated is not in the older pipeline but is in one of the younger pipelines, in such a case, instructions operating in the older pipelines have executed as anticipated and do not need to be replayed. However, given that this is a multiple issue machine, instructions from preceding execution stages will therefore be needed to be issue to the multiple pipelines if there are not to be bubbles. Thus, in one embodiment if a sufficient number of replay pointers are to be used for there to be a replay pointer that can be updated to a pending pointer for each instruction to be issued in the first stage following replay, a replay pointer is required to all instructions in the execution stage preceding the replay boundary and also to some replay pointers to instructions executing in the execution stage preceding this execution stage. In some embodiments, said data processing apparatus further comprises a shift data store operable to store multiple decoded instructions immediately prior to said multiple decoded instructions entering said multiple parallel pipelines.

A shift data store is also appropriate in the case of a multiple parallel pipelines in such a case the shift data store needs to be of a size to store multiple instructions such that there is at least one instruction stored for each parallel pipeline.

In some embodiments said data processing apparatus is operable on reading of a plurality of instructions from said queue for execution by said multiple execution pipelines to update said pointer value to indicate an instruction subsequent to said last instruction read from said queue and to decrease said pending value by a number of said plurality of instructions read from said queue and to increment said replay value by said number.

The decoded instructions can transition from being classified as pending to being classified as replayable simply by updating pointers and depths even when there are multiple instructions issued in a single cycle.

In some embodiments, said data processing apparatus is operable when a plurality of instructions within said multiple execution pipelines pass said replay boundary, to update said replay pointer to indicate an instruction subsequent to said instruction in said youngest pipeline that has just passed said replay boundary and to decrease said replay value by a number of said plurality of instructions that have just passed said replay boundary.

Similarly multiple instructions leaving the replay queue in a single cycle can be dealt with by updating the replay pointer and replay value appropriately. As it is the instruction in the youngest pipeline that is the instruction furthest down in the program sequence of the instructions leaving, it is the instruction subsequent to this in the program sequence that the replay pointer is updated to point.

In some embodiments, in response to said pending value being smaller than said number of parallel execution pipelines, said data processing apparatus is operable to read at least one of said instructions for execution by said pipelines from said instruction decoder and to write said at least one instruction to said instruction queue, and to update at least one of said replay value and said total value by incrementing it by at least one.

If the pending queue does not contain sufficient instructions to supply an instruction to each of the multiple pipelines, which may occur if the execution pipelines are operating faster than the fetch unit and decode, then the extra instructions required are read directly from decode. However, although they do not need to be entered into the pending queue they do need to be entered into the replay queue. Thus, they are entered into the hybrid queue as usual.

A further aspect of the present invention provides a method of processing data comprising: fetching instructions from a memory prior to sending said fetched instructions to an execution pipeline having a plurality of execution stages for execution; decoding said fetched instructions; storing a decoded instruction in an instruction queue at least one cycle prior to said decoded instruction being loaded into said execution pipeline, said instruction queue being arranged such that a next decoded instruction to be read from said instruction queue for execution by said execution pipeline is indicated by a pending pointer value and an instruction being executed in a furthest occupied execution stage of said execution pipeline prior to a replay boundary is indicated by a replay pointer value reading said instruction indicated by said pending pointer from said instruction queue for execution by said execution pipeline processor; removing a decoded instruction from said instruction queue upon said decoded instruction passing said replay boundary within said execution pipeline; and wherein prior to said instruction indicated by said replay pointer passing said replay boundary, evaluating whether said instruction has executed as anticipated and in response to detection of said instruction not having executed as anticipated: updating said pending pointer value with said replay pointer value; flushing instructions from said execution pipeline; resuming operation such that a next instruction to be read from said instruction queue for execution by said execution pipeline is said decoded instruction indicated by said updated pending pointer value.

A still further aspect of the present invention provides a means for processing data comprising: a pipeline processing means comprising an execution pipeline means for executing instructions in a plurality of execution stages; a fetch means for fetching instructions from a memory prior to sending those instructions to said execution pipeline; an instruction decoding means for decoding said fetched instructions; instruction evaluation means for evaluating if a decoded instruction has executed as anticipated prior to said decoded instruction passing a replay boundary within said execution pipeline means; means for storing a plurality of decoded instructions in an instruction queue, said means for processing data being operable to store a decoded instruction within said instruction queue at least one cycle prior to said decoded instruction entering said execution pipeline means and to remove said decoded instruction from said instruction queue upon said decoded instruction passing said replay boundary within said execution pipeline means, said instruction queue being arranged such that a next decoded instruction to be read from said instruction queue for execution by said execution pipeline means is indicated by a pending pointer value and an instruction being executed in a furthest occupied execution stage of said execution pipeline prior to said replay boundary is indicated by a replay pointer value; wherein in response to said instruction evaluation means detecting that said instruction indicated by said replay pointer has not executed as anticipated, said means for processing data is operable: to update said pending pointer value with said replay pointer value; to flush instructions from said execution pipeline means; and to resume operation such that a next instruction to be read from said instruction queue for execution by said execution pipeline means is said decoded instruction indicated by said updated pending pointer value.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically shows a data processing apparatus according to an embodiment of the invention;

FIGS. 2A to 2D schematically shows instructions within a hybrid queue during several subsequent clock cycles according to an embodiment of the present invention;

FIG. 3 shows a hybrid queue similar to that of FIG. 2 but including an additional shift queue portion;

FIG. 4 also shows a hybrid queue similar to that of FIG. 2 but including the additional shift queue portion;

FIG. 5 shows an instruction decode unit including the hybrid queue according to an embodiment of the present invention;

FIG. 6 shows the instruction decode pipeline in greater detail;

FIG. 7 schematically shows the watermark values of the hybrid queue 70;

FIG. 8 schematically shows further watermark values of hybrid queue;

FIG. 9 schematically shows the operation of a circular hybrid queue where the pending queue comprises some instructions over two cycles;

FIG. 10 schematically shows a pipeline diagram corresponding to the circular queue diagrams of FIG. 9;

FIG. 11 shows schematically the operation of a circular queue diagram where the pending queue is empty over two cycles;

FIG. 12 shows a pipeline diagram corresponding to the circular queue diagrams of FIG. 11; and

FIG. 13 schematically shows a replay entry sequence.

### DESCRIPTION OF THE PREFERRED EMBODIMENTS

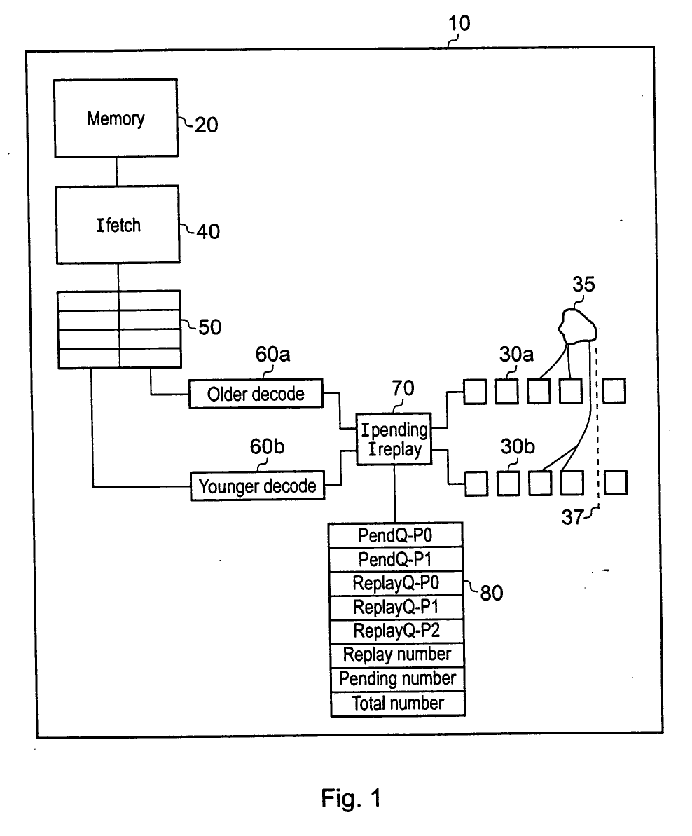

FIG. 1 shows a data processing apparatus 10 according to an embodiment of the present invention. The data processing apparatus 10 comprises a memory 20 (which may, for example be an instruction cache or a RAM) for storing instructions to be executed within the pipelined processor 30A, 30B. It comprises a prefetch unit 40 and a fetched instruction queue 50 for storing instructions fetched from the memory 20 prior to them being entered into the decode pipelines 60A, 60B. In the data processing apparatus illustrated, the processor is a dual pipe processor having dual issue of instructions, the instructions being decoded and executed in parallel in the two pipes. In the embodiment shown a hybrid queue 70 is used to isolate pre-decode section 60A, 60B of the processing apparatus 10 from the post decode section 30A, 30B. The hybrid queue 70 comprises both the traditional pending instruction queue used to store instructions waiting to be executed in the pipeline and also a replay queue, containing instructions that need to be reissued to the pipeline 30a, 30b in the event that an instruction does not execute as anticipated and needs to be replayed.

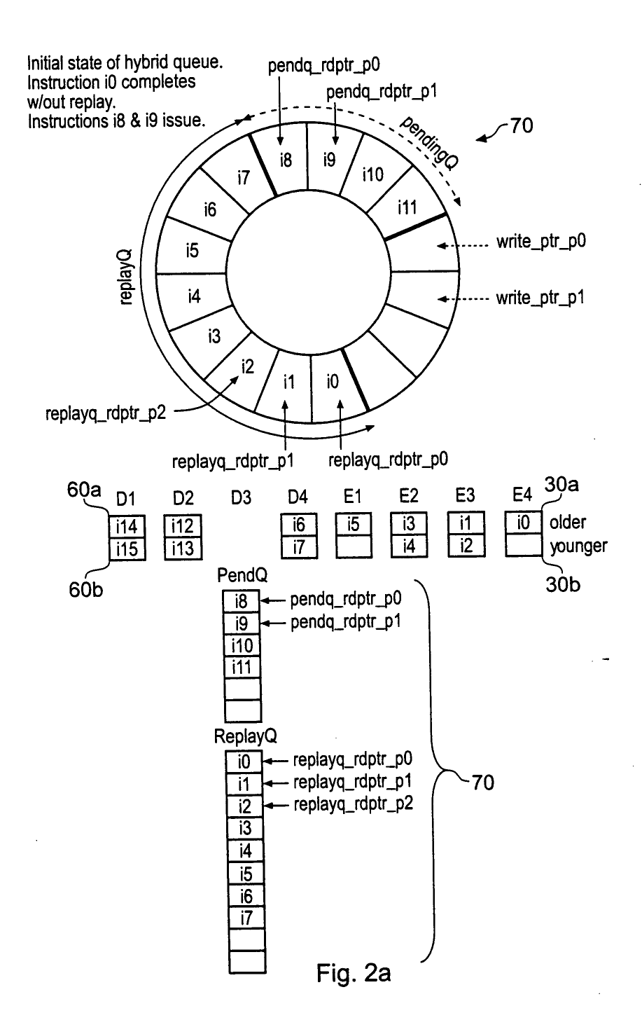

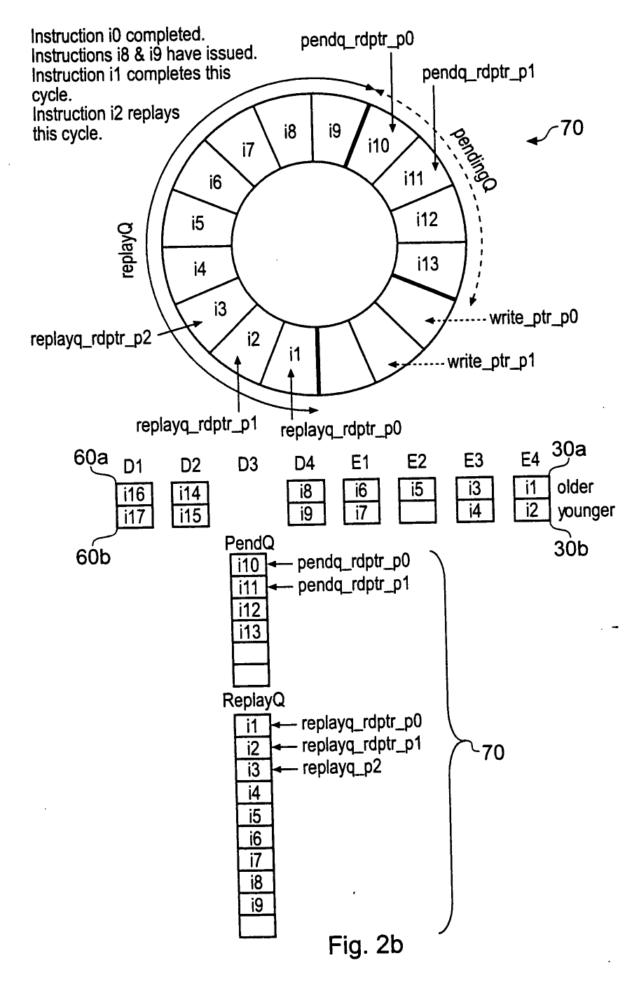

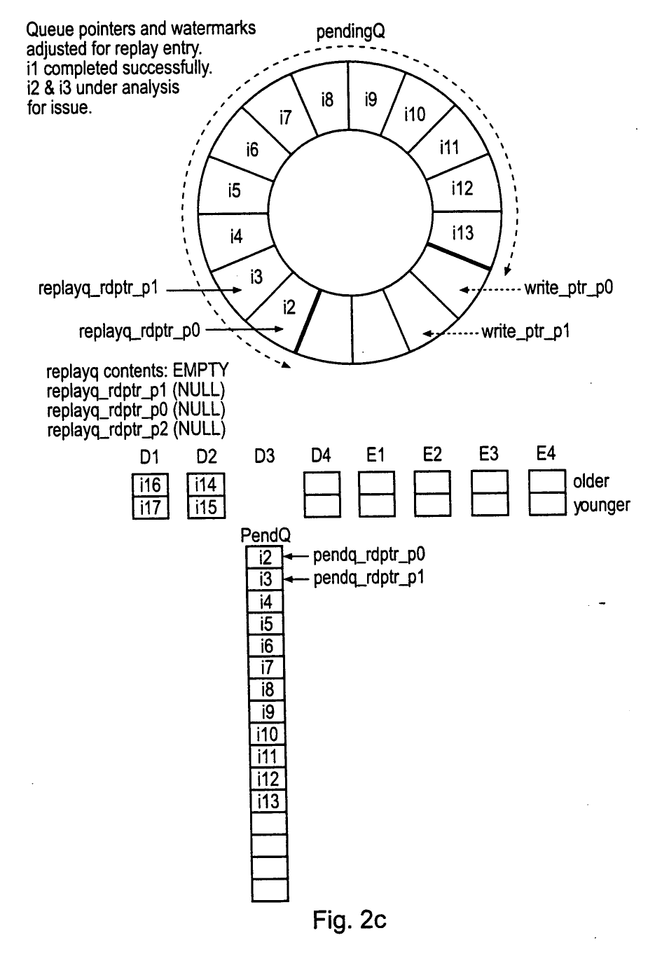

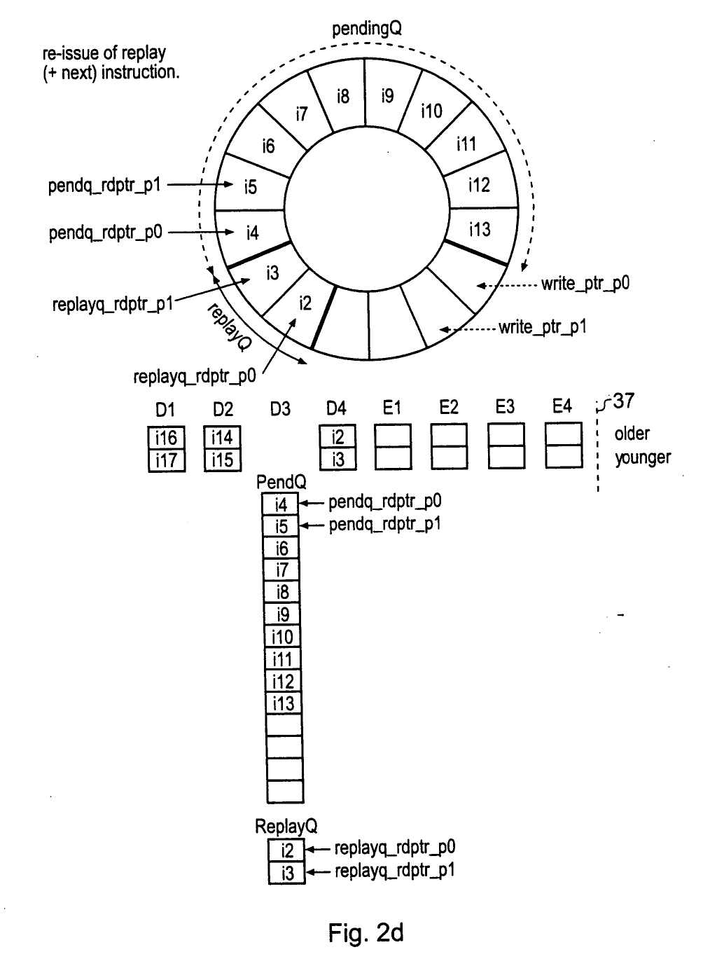

This hybrid queue has a data value store 80 associated with it. The data value store 80 stores pointers indicating positions within the queue and watermark values indicating the depths of specific portions of the queue. The pointers stored comprise two pending queue pointers which point to the next two instructions to be issued to the pipeline 30a, 30b, the first to the older pipeline 30a and the second to the younger pipeline 30b; and three replay queue pointers which point to the three last instructions being currently executed in the pipeline. The three last instructions are generally the two instructions executing in the final execute stages of the pipeline (E4 of FIG. 2) and the instruction executing in the older pipeline of the penultimate stage (E3 of FIG. 2). In the case that some of these stages do not hold a currently executing instruction then the instructions from immediately preceding stages are indicated by the replay pointers. In this embodiment there are three watermark values stored in the data value store: a replay watermark value indicating the number of instructions within the replay portion of the queue, a pending watermark value indicating the number of instructions within the pending portion of the queue, and a total watermark value indicating the total number of instructions present in the hybrid queue 70.

Evaluation logic 35 evaluates instructions executing in the final two execution stages of pipelines 30A and 30B before the replay boundary 37 to see if they have executed as anticipated.

FIGS. 2a to 2d schematically shows the status of instructions within the hybrid queue, decode stages of the decode pipeline 60a, 60b and execute stages of the execute pipeline 30A, 30B during several subsequent clock cycles. In the embodiment shown the instructions are issued strictly in order. Thus, as it is a dual issue processor, one of the pipelines 30A is an older pipeline, while the other 30B is a younger pipeline, an instruction from earlier within a program sequence entering the pipelined processor before or simultaneously with a subsequent younger instruction. Thus, if the two instructions are issued together, the older instruction enters the older pipeline and the younger instruction the younger pipeline substantially simultaneously.

The hybrid queue is shown schematically as a circular queue at the top of the figures and also as two separate queue portions at the bottom of the figures. In FIG. 2a instructions i0 to i5 are being executed in different stages El to E4 of the execution pipeline 30A, 30B, while instructions i12 to i15 are being decoded prior to the hybrid queue. Instructions i6 to i7 have been issued to the final decode section D4 from the hybrid queue 70 (the issue decision occurring in D3) and will enter the first stage of the execution pipeline 30 in the next clock cycle. As can be seen, this is a dual issue pipeline with two instructions being issued in parallel during at least some clock cycles.

The hybrid queue 70 can be viewed as a circular queue in that the next instruction to issue is not at the head of the queue but is simply at a position indicated by pending pointers. Thus, it is not the data that is moved within the queue but the pointers whose values are changed. This is an efficient way of implementing the queue as updating an address indicating the position of the next instruction to be issued is generally more power efficient than transferring data values between positions within a queue.

In the embodiment shown the pending pointer P0 points to instruction i8 and pending pointer P1 points to instruction i9, thus, instruction i8 will potentially be issued to the older pipeline 30a in the next clock cycle and instruction i9 to the younger pipeline 30b. The replay pointers in this embodiment point to the instruction iO being executed in the stage E4 of the execution pipeline preceding the replay boundary and to the preceding instructions i1, i2 executed in the penultimate stages of the pipeline.

FIG. 2b schematically shows the hybrid instruction queue 70 and the execute pipeline 30A, 30B and the decode pipeline 60A, 60B in the subsequent clock cycle to that shown in FIG. 2a. As can be seen, instructions i8 and i9 have issued from the instruction queue and are in the final stages of decode D4 prior to entering the execution pipeline 30A, 30B. They have also been transferred from the pending queue to the replay queue. This is not done by moving any data values, rather the pending pointers are moved to indicate subsequent instructions to be entered into the execution pipeline, in other words instruction i10 and instruction i11, and the depth of the replay and pending queues, i.e. their watermark values are amended. In this case the replay watermark is increased by 1 from 8 to 9, as i8 and i9 have joined the replay queue but iO has left it (having exited the execution pipeline). The pending watermark value stays the same at 4 as two instructions have left it but two have joined it. The pending pointers now point to i10 and i11 which are the next two instructions to be issued to the pipeline while the replay queue pointers point to the final three instructions being executed in the pipeline which are now i1, i2, and i3. There are three replay pointers in this embodiment as if the instruction that fails to execute properly is in the younger pipeline rather than the older pipeline then it is this instruction and the instruction after it which need to be reissued, the execution of the instruction in the stage of the older pipeline immediately preceding the replay boundary having completed successfully. Thus, it is necessary to know not only the instruction which did not execute as anticipated but also the instruction after it so that it is these two that can be the first two instructions to be issued to the pipeline on replay. This will become clear with reference to FIG. 2c and 2d.

FIG. 2c shows the next clock cycle, during which i1 has completed successfully but i2 did not. It should be noted that instructions are fed to the queue in program sequence order. Some instructions require data that has been amended by a previous instruction. Generally the data will be amended and ready to be accessed, however, in some situations the previous instruction may have taken longer to execute than expected. For example, the data that the previous instruction was updating may not have been stored in a cache and thus, memory would have needed to be accessed. In such a circumstance the data will not be updated in time for the subsequent instruction. In such a case the destination result register of the previous instruction is annotated as invalid and evaluation logic (35) (see FIG. 1) determines that the subsequent instruction in this case i3 cannot execute correctly as the data it needs is not ready. In other words i2 has not executed as anticipated and the pointers and watermarks are updated and the hybrid queue becomes in effect a large pending queue which acts to replay i2 and instructions subsequent to it automatically. By simply turning the hybrid queue into a pending queue, there is no need to maintain any information to make the processor behave differently during replay. It simply acts as usual, processing instructions from within its pending queue.

As it is the younger of the two instructions i2 that has not executed as anticipated, it is the replay pointer 1 and replay pointer 2 whose values are written into the pending pointers. In other words, pending pointer P0 gets the value stored in replay pointer 1 and pending pointer P1 gets the value stored in replay pointer 2. The watermark value for the depth of the pending queue is then re-written to contain the number stored in the total watermark, i.e. the total number of instructions in the hybrid queue. In other words, the queue then becomes a large pending queue.

Instruction i2 and all the instructions after it within the pipeline are then issued from the pending queue to the pipeline and replay is assured. Furthermore, the pending queue is set up as most pending queues are, such that if it is longer than a certain value then the pipeline prior to the queue i.e. decode and fetch are stalled. Thus, when replay occurs the pending queue may in effect become very long and thus the pipeline prior to the queue is automatically stalled without there needing to be an additional functional unit to implement this. The issue of instructions and the control of the queue then proceeds in the normal way.

FIG. 2d shows the next clock cycle wherein instructions i2 and i3 being the instructions indicated by pending pointers P0 and P1 in FIG. 2c are issued to the final stage of decode D4 prior to entering the execution pipeline 30 and the pending pointers are updated such that i4 and i5 are indicated by P0 and P1. The replay pointers point to i2 and i3 being the oldest two instructions within the pipeline. At the same time the pending queue watermark is reduced by two while the replay instruction watermark is increased by two. This divergence of the pending and replay entries uses the same logic as is required to control the queue of the processor and thus, such a system requires no unique logic. It should be noted that although replay pointer points to instruction in the first stage of the pipeline immediately following replay, these instructions are not evaluated to see if they have executed correctly until they reach the stage preceding the replay boundary, or in some embodiments the two stages preceding the replay boundary of the pipeline.

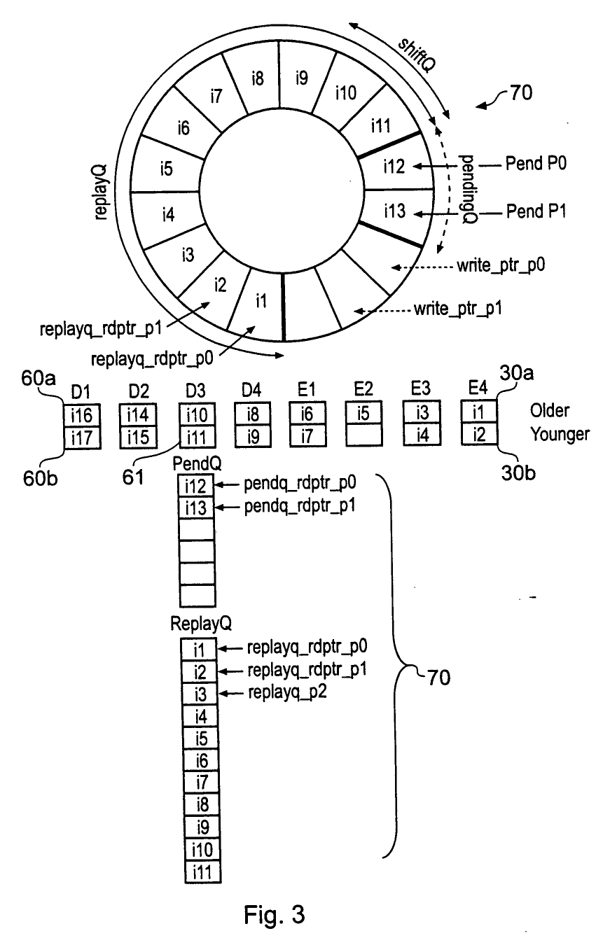

In the embodiment shown in FIG. 2 instructions are issued directly from the “circular queue” to the pipeline. In preferred embodiments, it has been found to be advantageous to place a shift queue between the circular queue and the pipeline. FIG. 3 illustrates this idea. The shift queue 61 is located at position D3 and although it consumes power as the data needs to be shifted within this queue and thus moved rather than just the pointers being moved, it does mean that instructions are ready for immediate entry into the issue analysis logic and this reduces possible time delays at the point where the instructions are issued to the pipeline. It has been found that the increase in power needed for this small shift queue is acceptable when compared to the advantages gained due to a decrease of time occurring within the critical pathway. In all other ways the queue shown in FIG. 3 acts like that shown in FIG. 2.

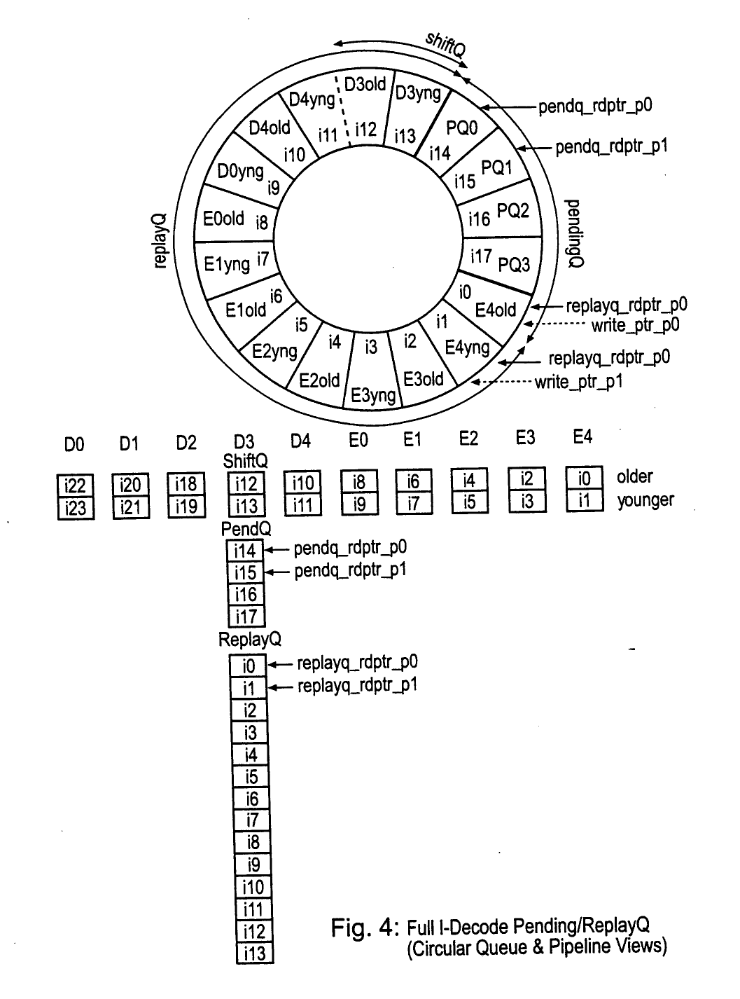

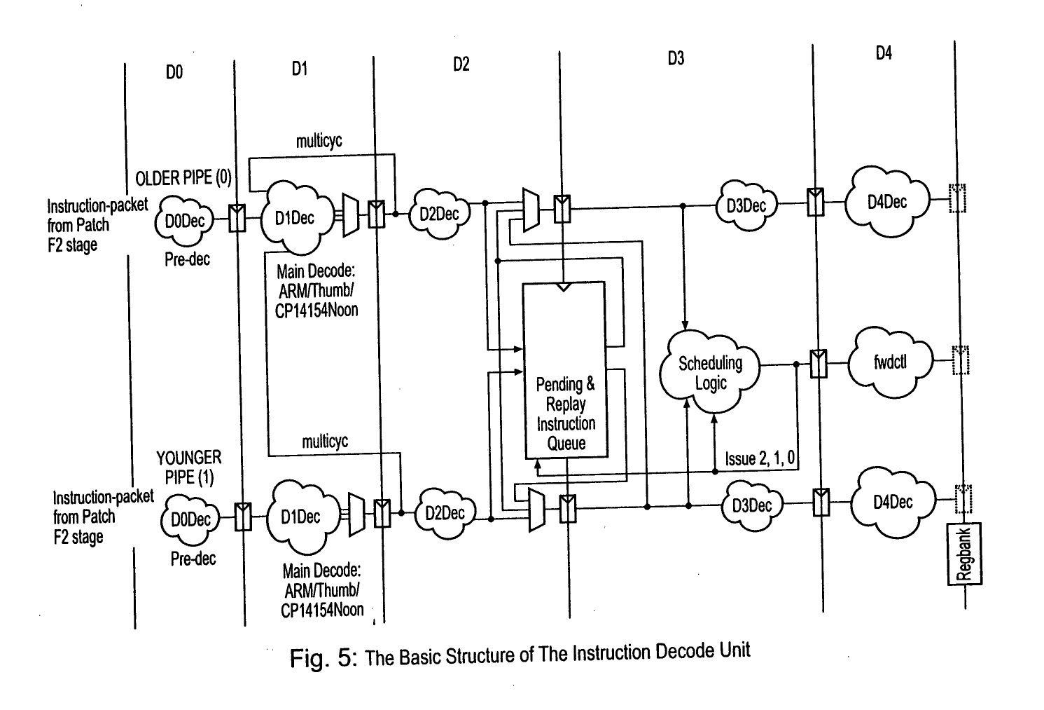

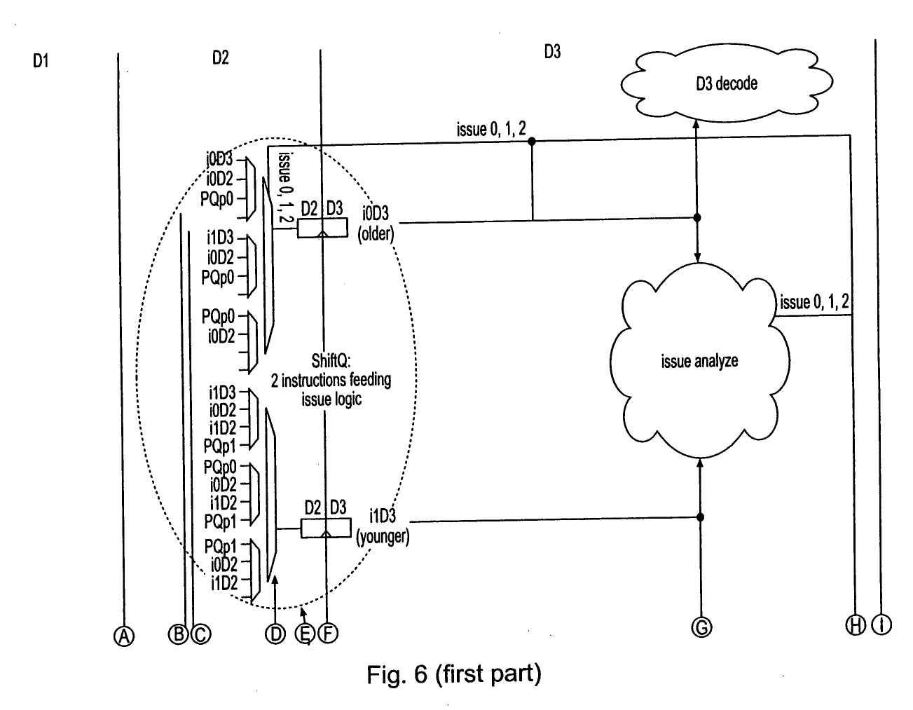

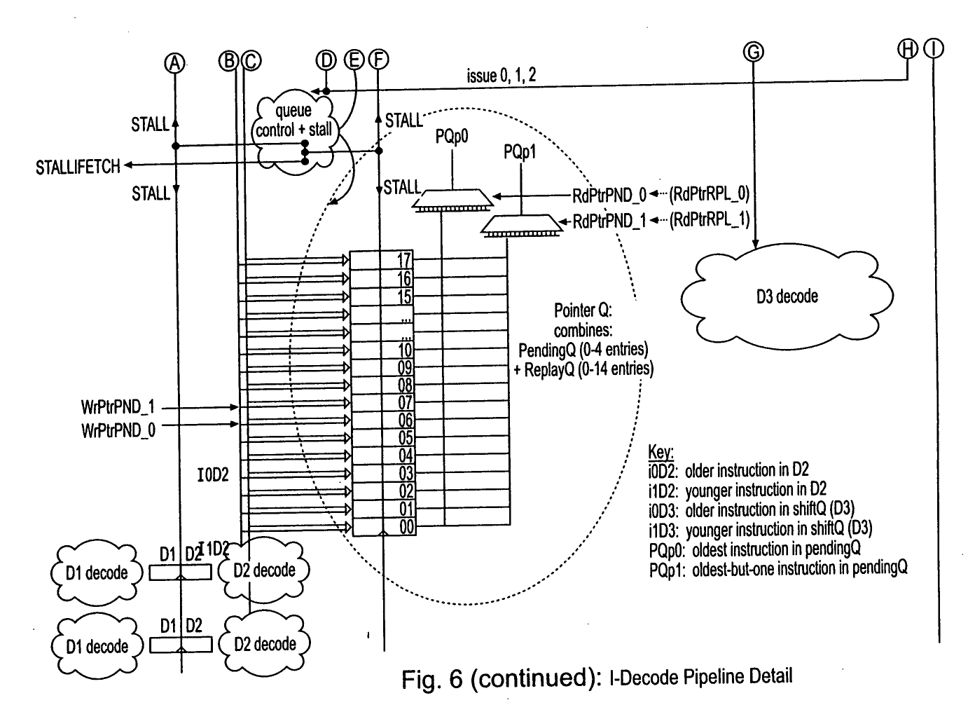

As can be seen from the systems shown in FIGS. 2 and 3 instructions always enter the hybrid queue at the same point, in the examples shown following decode stage D2. They transition from the pending classification to replay classification as they are issued to decode stage D4 and they exit replay queue on executing execution stage E4 and passing replay boundary 37. The advantage of having this common entry point is that data does not need to be switched between queues rather only the pointers and watermark values are altered. In the embodiment shown in FIG. 4, in some instances the instruction may not enter the hybrid queue with pending classification, but it will always enter the hybrid queue, in this case going in initially with replay classification. This occurs when the pending queue becomes empty. In such a case at the next clock cycle instructions are shifted straight from decode stage D2 to D3 (the shift queue) without entering the pending queue. They do however enter the hybrid queue 70 being entered directly into the replay classification of this queue.

Further details of a preferred embodiment of the present invention are given below.

Shift Queue and Combined Pending/Replay Queue

### Shift Queue

The next one or two instructions waiting to issue in D3 are held in the “shift queue”.

The shift queue is fed from a number of (or combination of) sources:
from D2 direct (if there are no pending instructions in the pending queue)
from the pending queue (when there are pending (or replay) instructions)
from itself (for shuffling previous-cycle's younger to current-cycle's older)

The shift queue can be thought of as the bottom 2 entries in the entire I-Decode instruction queuing amalgam. Instructions residing in the shift queue are often referred to in this and other documents as the instructions in the D3 stage of the pipeline. The shift queue is not built with read/write pointers; rather it has dedicated muxes feeding the critical 2 entries (iOD3 “oldest”, i1D3 “oldest-but-one”). Data does shuffle into and between entries in the shift queue on a per-cycle basis. If only one instruction issues, the oldest-but-one instruction shifts to the oldest position at the beginning of the next cycle. If two instructions issue, the next-oldest instructions from either the pending queue or stage D2 (or a combination of) lands in the shift queue. The contents of the shift queue are exclusive of the contents of the pending queue; however the contents of the shift queue do also exist in the replay queue.

### Pending Queue

The pending instruction queue holds instructions not yet analyzed for issue and serves the critical function of decoupling earlier stages in the pipeline from the timing-critical issue 0, 1, or 2 decisions. Earlier stages in the pipeline are stalled when a high-water- mark indicates that without the stall it would be possible to not have enough space in the pending queue to store instructions that are in-flight in the decoders. It is imperative that all stalls be generated early (out of a flop) due to its large fanout. The pending queue also serves to collapse bubbles in the instruction stream. This occurs once backpressure (from zero-issue or single-issue cycles) has allowed a number of pending-issue instructions to accumulate. (Instructions typically arrive two-per-cycle, and data & resource dependencies can quite often cause single or zero issue cycles). Instructions in the pending queue are close-packed as they are inserted into the queue. As long as the pending queue is not empty, bubbles will be removed as part of normal operation. The pending queue maximizes opportunities for pairing instructions by always presenting the issue-analysis logic with 2 instructions whenever there is a backlog of pending-issue instructions. Note though, that in cases where one rather than two instructions arrive in the shift queue (issue analysis stage) and there is no backlog of pending-issue instructions, it is advantageous to issue the single new instruction immediately rather than wait to potentially pair it with a following instruction.

### Replay Queue

The replay queue allows instructions that do not execute “as expected” to be flushed and restarted without having to re-fetch them from the instruction cache. “As expected” refers to the principle that all destination register results can be precisely annotated up-front, specifying their result-valid cycle purely as a function of decoding the instruction itself. This principle is one of the fundamental tenants of Tiger's “fire- and-forget” (non-stalling) pipeline. An instruction is replayed when its destination register(s) are unavailable at the expected time. Replay is restricted to load- and store- type instructions. The replay queue tracks all the information necessary to restart instruction execution from the end of D2. The replay queue must have enough depth to cover all outstanding instructions between D3 (issue-analysis stage) and E4 (replay stage), inclusive. Implemented as part of a combined pending queue and replay queue structure, the replay queue is also close-packed and exhibits the same bubble-collapsing characteristics of the pending queue.

### Combined Pending/Replay Queue Implementation

The position in the pipeline of the replay queue determines its width and depth. The earlier the queue sits in the pipe, the deeper but narrower it is and the greater the number of cycles it costs to replay an instruction. At one extreme replay could be implemented by re-fetching instructions from the I-cache. At the other extreme replay could be implemented using a queue of all the control signals crossing the decode-execute issue point. A reasonable compromise between width and depth is to position the replay queue at the same point in the pipeline as the pending queue. This reduces overall complexity by allowing the replay and pending queues to be combined into one queuing structure with identical entries (exact match between number and purpose of each bit).

Separate pending and replay queues present an array of comer-cases in the transitioning from “normal” (pending) instruction sequencing to replay instruction sequencing, and more importantly from replay sequencing back to normal sequencing. Managing the instruction sequencing functionality with separate queues involves a large number of area/complexity tradeoffs. Under a separate queue scheme, the replay queue was envisioned as a rigid 2-entries-per-stage, bubble-preserving structure that contained enough entries to encompass all stages between D3 & E4 (inclusive) plus the pending queue depth. A separate replay queue can contain a larger number of instructions than can be dealt off before the initially replayed instruction reaches e4 again (& potentially re-replays). The occurrence of a re-replay while still dealing off the contents of the replay queue was not allowed¹ to avoid creating complex structures to manage the queues.
¹ Re-replays refers to a repeat replay of a replayed instruction. Note that replays during replay (before the replayed instruction reached E4) are not supported (there will not be any valid instruction in E4 until the replayed instruction has reached that stage)

Combining the pending & replay queues into a single structure affords considerable logic simplification and reasonable area reduction. A simplifying characteristic of replay handling under the combined queue scheme is the existence of a well-defined and rigid replay entry sequence but no exit sequence at all. Replay entry effectively grows the pending queue beyond its normal limits, by adjusting the pending queue read pointers and watermarks only as part of a replay entry sequence. Once the replayed instruction is allowed to cross the issue boundary (D3 to D4), no further knowledge of replay state is required. Typically during replay the over-sized pending queue will stall receipt of new instructions until enough instructions have been issued such that the pending queue size is back in the realm of normal activity, at which point the stall (holding D2, D1, D0 and IF) will be de-asserted. Instruction sequencing/issuing activity that occurs as part of dealing-off replay entries is generally indistinguishable from normal pending instruction issue (aside from the fact that the pending queue contains a larger-than-normal number of entries). Re-replays simply involve the same replay-entry pointer adjustment scheme as an initial replay.

The combined pending and replay queue structure is termed the “pointer queue”. It is built as a circular queue with read and write pointers. Entries in the pointer queue must fall into 1 of 2 categories, replay entries or pending entries. Separate read pointers and watermarks delineate whether an entry is a replay entry or a pending-issue entry. FIG. 4 illustrates a completely full pointer queue (circular queue diagram) and its corresponding completely full (D3-E4) pipeline (pipeline diagram). D0, D1, and D2 are shown on the pipeline diagram for completeness of showing all instructions that could be live in I-Decode (D0, D1, and D2 are not tracked in the pointer queue).

The combined queuing structures of the pointer queue and shift queue form a “hybrid” queue, combining the power and area advantages of the pointer queue (no data shuffling, simpler input mux scheme) for the majority of entries with the timing advantages of the shift queue for the 2 entries under analysis for issue as the critical last stage. The mux scheme for writing the shift queue entries is structured such that the issue 0,1,2 term is the sole control of the final mux feeding the shift queue flops. It is also important to have the shift queue flops directly feed the issue analysis and scoreboard lookup logic, hence the shift queue structure with fixed entries (no read port, as opposed to the pointer queue scheme which necessarily involves read port muxing).

### Terminology

In describing the instruction issue/sequencing scheme and the queuing structures, these terms are used:
pointer queue The combined pending queue / replay queue structure, built as an array of entries with 2 write pointers (an “older” and “younger” instruction can be accepted each cycle), 2 read pointers for the pending queue, and 2 read pointers for the replay queue. There is a single set of 2 read ports in the pointer queue structure, the steering terms for these read ports are always sourced from the 2 pending queue read pointers (the pending queue read pointers are overwritten with replay queue read pointer values at replay entry).
pending queue The pending instruction portion of the shift queue. 0-4 macro-op entries.
replay queue The replay instruction portion of the shift queue. 0-14 macro-op entries.
shift queue Sometimes referred to as “stage23” (spans D2, D3 stages), the shift queue contains the oldest and oldest-but-one instructions that are being analyzed for issue. As Tiger is dual-issue and in-order, these are the only instructions that the issue logic needs to see.
macro-op/micro-op

A macro-op corresponds to an instruction op-code as seen in an assembly level listing. In I-Decode, it will be decoded into more than 32-bits. A micro-op is an element of a macro-op that indicates the operation to be performed by the execute units in one single cycle. A single cycle macro-op is decoded into one micro-op, whereas a multi-cycle macro-op decodes into many micro-ops. The pending queue and replay queue store micro-ops.
watermark A count of the number of valid entries in a queue.

### Pending Queue Details

The pending queue stores decoded micro-ops and has a depth of 4 entries. It is built as a part of a circular queue of 18 total entries for both pending instructions and replay instructions. The pending instructions within the pointer queue can be any 0-4 contiguous entries in the structure. Two write pointers track the insertion point for the next 2 decoded instructions from D2. Two read pointers track the oldest (PQp0) and oldest-but-one (PQp1) entries in the pending queue. Instructions from D2 may bypass the pending queue portion of the pointer queue when the pending queue is empty (but must be preserved as replay queue entries in the pointer queue). Separate pending queue vs. replay queue read pointers and watermarks (counts of number of entries) distinguish exactly which entries in the combined pointer queue comprise the pending queue and which entries comprise the replay queue.

For purposes of stall generation and shift queue mux steering, 2 separate watermarks are maintained:
1. The “idu” watermark tracks all entries in D3, ie. those in the shift queue and the pending queue. Under normal activity its maximum is 6: D3/shift queue(2) +pending queue(4). Knowledge of the number of incoming instructions into this idu zone is encapsulated in the D2 stage instruction valid bits. Knowledge of the number of outgoing instructions from this idu zone is delineated by the critical issue0,1,2 indicators. By maintaining a next-state for the idu watermark as well as a next-state for the idu stall, the critical pending queue hold term (which stalls D2, D1, D0, and I-Fetch) can be delivered directly from a flop.
2. A “pending queue” watermark strictly tracks the number of entries in the pending queue (0-4), and is used to steer the critical shift queue input muxes. The pending queue watermark feeds into the logic that dictates on each cycle boundary where the next 2 instructions dropping into the shift queue should come from: D2 older (i0D2), D2 younger (i1D2), pending queue older (PQp0), pending queue younger (PQp1), or shift queue recirculated/shifted values (i0D3, i1D3).

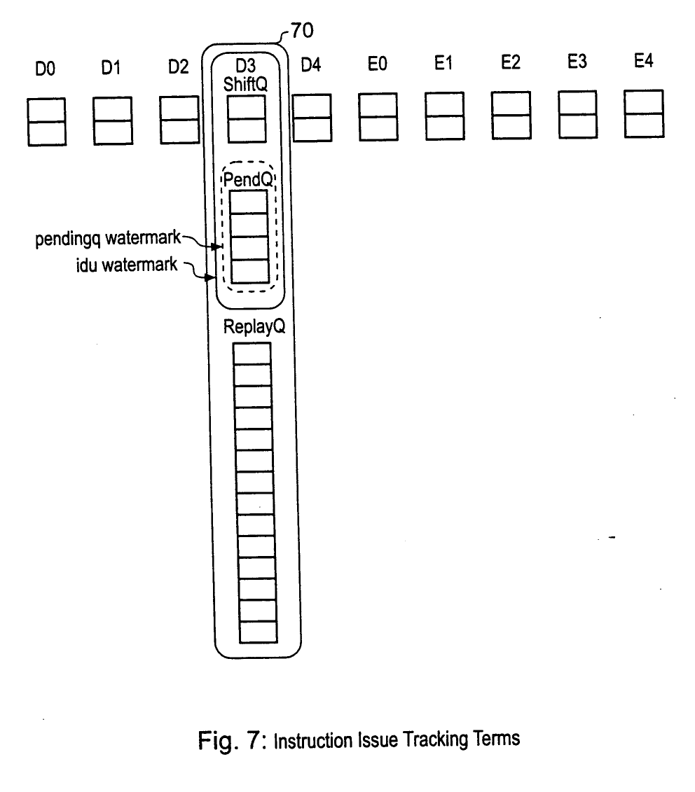

FIG. 7 depicts the watermarks involved in tracking instruction issue:

Key relationships tracking the overall instruction activity are:

idu watermark next-state (ns_idu) = idu watermark current-state + incoming (D2 valid) −
outgoing (D3 issued)
idu watermark current-state (cs_idu) = D3(shift queue) entries + pending queue
entries
idu netgain = incoming (D2 valid) − outgoing (D3 issued)

| | |
|---|---|
| idu stall next-state = | (cs_idu=3, idu_netgain=+2) \| |
| | (cs_idu=4, idu_netgain=+2 \| +1) \| |
| | (cs_idu=5, idu_netgain=+1 \| +0) \| |
| | (cs_idu=6, idu_netgain=+0 \| −1) |

(idu stall next-state: stall anytime idu watermark next-state (ns_idu) is greater-than-
or-equal-to 5).
idu stall current-state: prevents F2-> D0, D0-> D1, D1-> D2, and D2 -> D3
advancement

### Pending Instruction Queue Depth

The number of entries required in the pending instruction queue depends on the amount of decoupling required between the issue logic's Issue-none, one or two instruction calculation (Issue-012) and the up-stream interlock signal. Clearly it is impractical to propagate an interlock signal derived directly from Issue-012 in the same cycle that it is evaluated. The approach taken involves generating the interlock signal based on Issue-012, registering it and then propagating it in the following cycle. The Issue-012 information indicates outgoing instructions; the only other information factoring in is the current queue state and the number of incoming instructions. Effectively, the signal going into the flop that produces the interlock is generated from the next-queue state rather than the current queue state.

The current queue state is available early but generation of the next-state of the interlock from Issue-012 is tight. However, Issue-012 also has to steer the shift queue and gate the scoreboard write enables, so it has to be valid at least few gates before the end of the cycle.

Four entries are enough to allow the queue to generate an early interlock signal out of a flop, absorb a reasonable number of incoming bubbles, and prevent the introduction of any additional outgoing bubbles (because the early interlock signal stalls registers on all boundaries (F2->D0, D0->D1, D1->D2, and D2->D3)).

The following table shows an example of pending queue utilization over several cycles variable numbers of instructions available in D1 stage, and varying instruction issue rates from D3.

| | | | | | | | | | | next | current | | |
|---|---|---|---|---|---|---|---|---|---|---|---|---|---|
| | | | | | | | | Out | | state | state | next | current |
| | | | | | | | In | (D3 | | idu | idu | state | state |
| | | | | | | | (D2 | issue | Net | water- | water- | idu | idu |
| CYCLE | PIPE | D1 | D2 | D3 | PendQ | D4 | vld) | 0, 1, 2) | Gain | mark | mark | stall | stall |
| 00 | 0 | i00 | | | | | +0 | −0 | +0 | 0 | 0 | 0 | 0 |
| | 1 | i01 | | | | | | | | | | | |
| 01 | 0 | i02 | i00 | | | | +2 | −0 | +2 | 2 | 0 | 0 | 0 |
| | 1 | i03 | i01 | | | | | | | | | | |
| 02 | 0 | i04 | i02 | i00 | | | +2 | −1 | +1 | 3 | 2 | 0 | 0 |
| | 1 | i05 | i03 | i01 | | | | | | | | | |
| 03 | 0 | i06 | i04 | i01 | [i03] | i00 | +2 | −2 | +0 | 3 | 3 | 0 | 0 |
| | 1 | — | i05 | i02 | | — | | | | | | | |
| 04 | 0 | i07 | i06 | i03 | [i05] | i01 | +1 | −1 | +0 | 3 | 3 | 0 | 0 |
| | 1 | i08 | — | i04 | | i02 | | | | | | | |
| 05 | 0 | i09 | i07 | i04 | [i06] | i03 | +2 | −0 | +2 | 5 | 3 | 1 | 0 |
| | 1 | i10 | i08 | i05 | | — | | | | | | | |
| 06 | 0 | i11 | i09 | i04 | [i06] | — | +0* | −1 | −1 | 4 | 5 | 0 | 1 |
| | 1 | — | i10 | i05 | [i07] | — | | | | | | | |
| | | | | | [i08] | | | | | | | | |
| 07 | 0 | i11 | i09 | i05 | [i07] | i04 | +2 | −2 | +0 | 4 | 4 | 0 | 0 |
| | 1 | — | i10 | i06 | [i08] | — | | | | | | | |
| 08 | 0 | i12 | i11 | i07 | [i09] | i05 | +1 | −2 | −1 | 3 | 4 | 0 | 0 |
| | 1 | — | — | i08 | [i10] | i06 | | | | | | | |
| 09 | 0 | i13 | i12 | i09 | [i11] | i07 | +1 | −1 | +0 | 3 | 3 | 0 | 0 |
| | 1 | — | — | i10 | | i08 | | | | | | | |
| 10 | 0 | i14 | i13 | i10 | [i12] | i09 | +1 | −1 | +0 | 3 | 3 | 0 | 0 |
| | 1 | i15 | — | i11 | | | | | | | | | |
| 11 | 0 | i16 | i14 | i11 | [i13] | i10 | +2 | −1 | +1 | 4 | 3 | 0 | 0 |
| | 1 | i17 | i15 | i12 | | | | | | | | | |
| 12 | 0 | i18 | i16 | i12 | [i14] | i11 | +2 | −1 | +1 | 5 | 4 | 1 | 0 |
| | 1 | — | i17 | i13 | [i15] | | | | | | | | |
| 13 | 0 | i19 | i18 | i13 | [i15] | i12 | +0* | −2 | −2 | 3 | 5 | 0 | 1 |
| | 1 | i20 | — | i14 | [i16] | | | | | | | | |
| | | | | | [i17] | | | | | | | | |
| 14 | 0 | i19 | i18 | i15 | [i17] | i13 | +1 | −0 | +1 | 4 | 3 | 0 | 0 |
| | 1 | i20 | — | i16 | | i14 | | | | | | | |
| 15 | 0 | i21 | i19 | i15 | [i17] | — | +2 | −2 | +0 | 4 | 4 | 0 | 0 |
| | 1 | i22 | i20 | i16 | [i18] | — | | | | | | | |
| +0* is used to indicate that the instruction valid bits are squelched as a function of current state stall. | | | | | | | | | | | | | |
| Note: | | | | | | | | | | | | | |
| The next-state hold is formed as a function of D2 incoming and D3 outgoing instructions. As such, to avoid asserting a hold the pending queue must be able to accept two incoming instructions from D2 in the next cycle. If only one or zero slots will be available in the pending queue in the next cycle, next-state hold must fire. There is no generic mechanism to shuffle instructions between pipes in decode if just one of two instructions were to be taken. Another way of saying | | | | | | | | | | | | | |
| # this is that pipeline advancement transfers “all-or-none” of its contents from one stage to the next. The queue write logic must be able to close-pack the queue based on indicators of valid incoming instructions and the number of instructions that will issue. | | | | | | | | | | | | | |

Note:
Current-state idu stall prevents F2 (I-Fetch) from advancing to D0, D0 from advancing to D1, D1 from advancing to D2, and D2 from advancing to pending queue or shift queue (D3). Current-state idu stall must not prevent instruction issue (D3 to D4 advancement).

### Replay Queue Details

The replay queue stores decoded micro-ops and has a depth of 14 entries. It is built as a part of the circular pointer queue containing 18 total entries for both pending instructions and replay instructions. The replay queue instructions within the pointer queue can be any 0-14 contiguous entries in the structure. Two write pointers track the insertion point for the next 2 decoded instructions from D2. Instructions from D2 must be preserved as replay queue entries in the pointer queue. Two read pointers track the oldest (RQp0) and oldest-but-one (RQp1) entries in the replay queue. These pointers designate the replayable instruction(s) in E4. When replay fires, associated with it is an older/younger indicator that dictates which of the (potentially) 2 instructions in E4 replayed. There is a pipeline (D4-E4) of issue0,1,2 values in I-Decode control logic —this is necessary to track how many instructions exit the replay queue each cycle.

On replay, the pending queue is grown as part of a replay entry sequence to encompass not only the current pending queue entries, but also the current replay queue entries. This is accomplished by a “total queue” watermark that tracks all entries in the pending queue and replay queue. Its range is 0-18. On replay, the total queue watermark overwrites the pending queue watermark and the idu watermark. The new pending queue depth is effectively the old pending queue plus the old replay queue.

All of the replay overwrite values (watermarks and pointers) are adjusted appropriately based on whether the older or younger instruction replayed. The replay queue read pointers overwrite the pending queue read pointers, and the micro-op to be replayed plus the next instruction drop into the shift queue for issue analysis. Once the replayed instruction is allowed to issue, the effect is “normal” instruction sequencing from this point forward with an over-sized pending queue. No replay state exists beyond issue of the replaying micro-op.

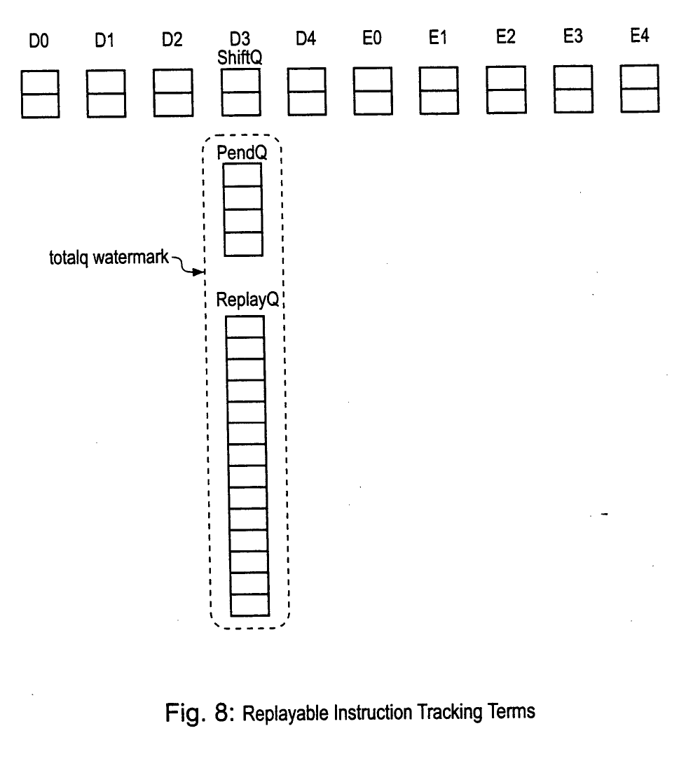

FIG. 8 depicts the watermarks involved in tracking replayable instructions:

### Pending Queue/Replay Queue Operation

To illustrate how entries in the pointer queue are managed to satisfy the functionality of a pending-instruction queue and a replay-instruction queue, several diagrams & scenarios are presented here.

i. Pending instructions>0

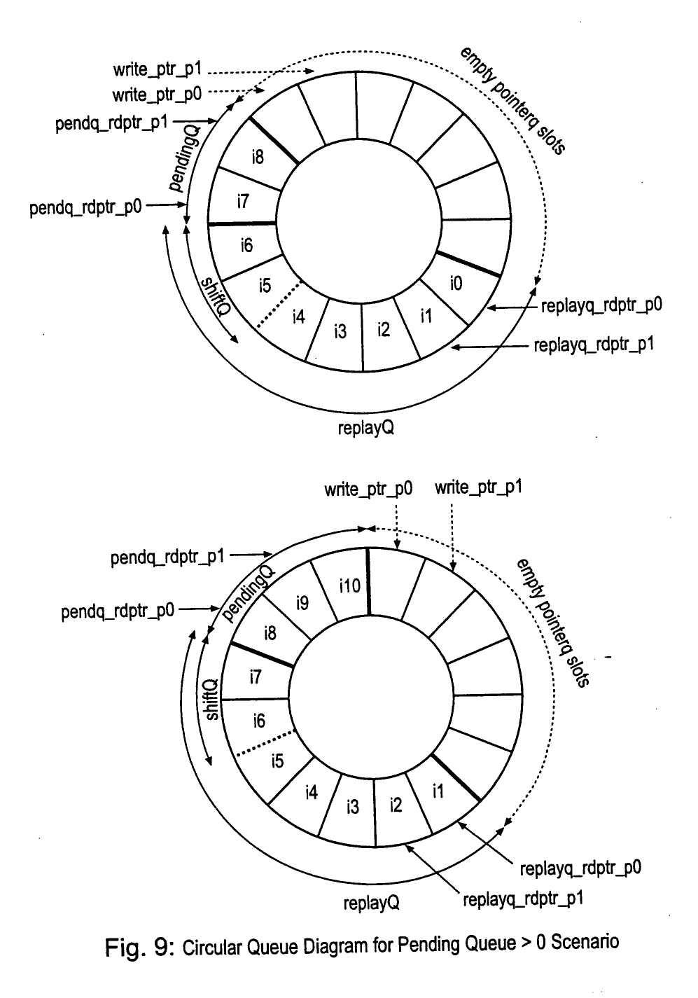

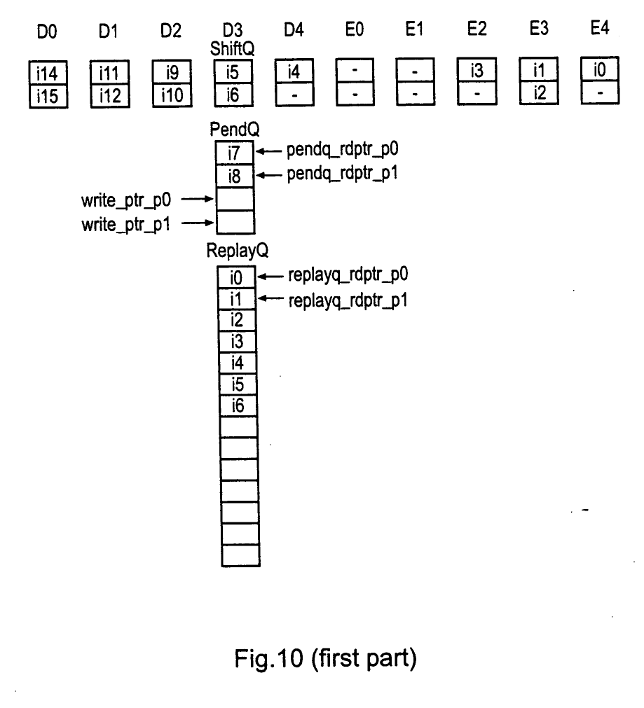

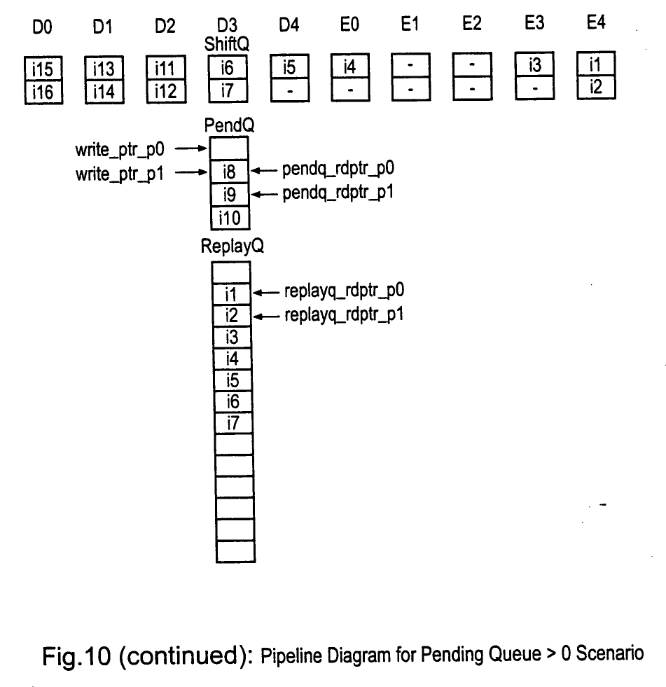

FIGS. 9 and 10 depict queue activity for this scenario:
Pending queue contains 2 entries, shift queue contains 2 entries, replay queue contains 7 entries, 1 instruction completes E4, 1 instruction is allowed to issue, 2 instructions are in D2.

In the first cycle, the pending queue contains 2 instructions (i7, i8). Instructions i0 thru i4 live at various stages in the pipeline between D4 (just after the issue-point) and E4 (replay-point). Instructions i5 and i6 are in the D3 stage, i.e. they reside in the shift queue and are therefore being analyzed for issue. In this scenario, i0 completes in E4 without replaying, i5 is determined to issue, i6 is determined not to issue. There is a pipeline (D4-E4) of issue0,1,2 values in I-Decode control logic —this is necessary to track how many instructions exit the replay queue each cycle.

In the second cycle, i6 has advanced from the previous cycle's “younger” position in the shift queue to this cycle's “older” position, i7 has advanced from the pending queue to the shift queue's “younger” position, i9 & i10 have advanced from D2 to the pending queue. No shuffling of data in the actual pointer queue entries has occurred. Instead, read and write pointers and watermarks have been adjusted to designate that i8, i9, i10 now reside in the pending queue, i1-i7 now reside in the replay queue. Shuffling of entries in the shift queue has occurred. Note that the replay queue maintains duplicates of the instructions residing in the shift queue. It must do so in order to be able to re-start these instructions if they replay upon reaching E4.

ii. Pending instructions=0

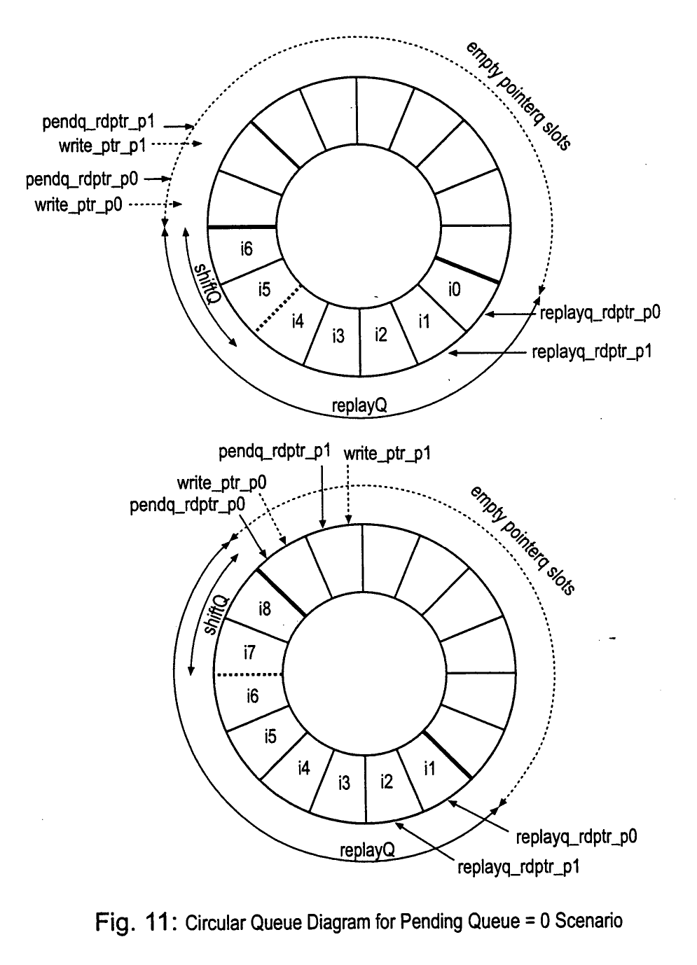

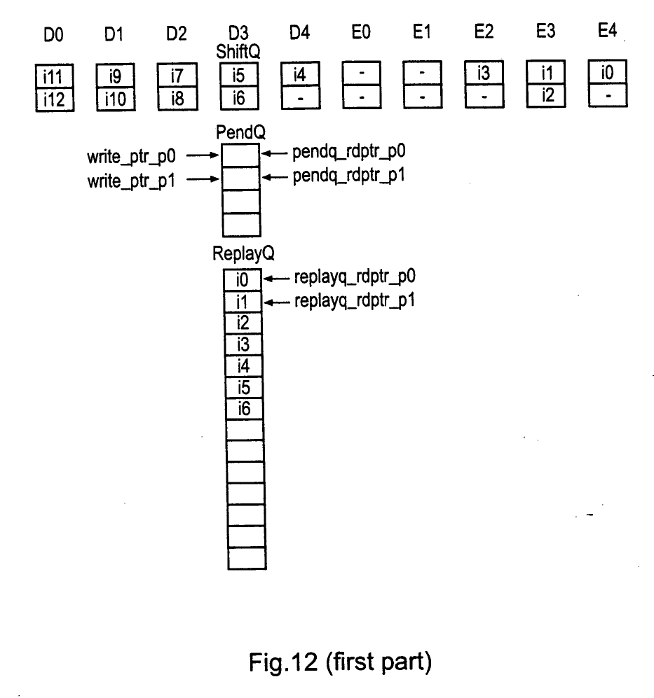

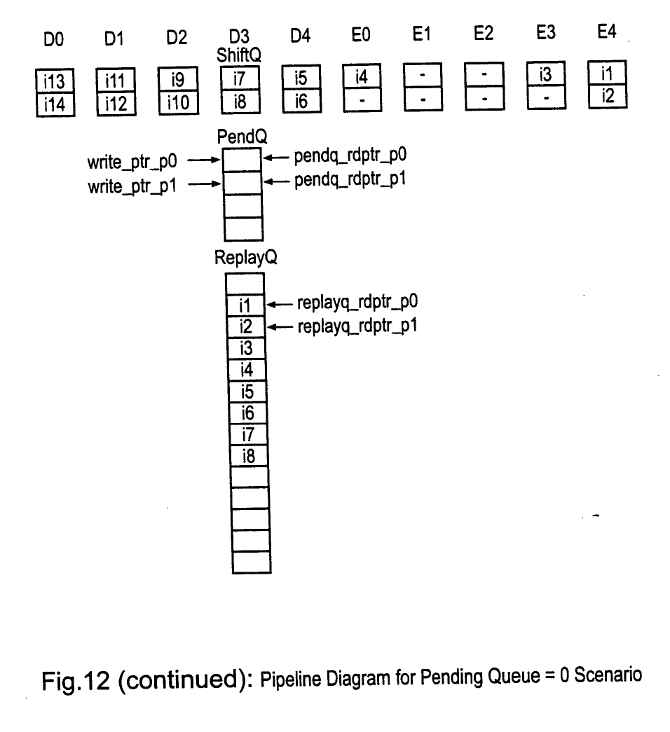

FIGS. 11 and 12 depict queue activity for this scenario:
Pending queue contains no entries, shift queue contains 2 entries, replay queue contains 7 entries, 1 instruction completes E4, 2 instructions are allowed to issue, 2 instructions are in D2.

In the first cycle, the pending queue contains no instructions. Instructions i0 through i4 live at various stages in the pipeline between D4 (just after issue-point) and E4 (replay-point). Instructions i5 and i6 are in the D3 stage, i.e. they reside in the shift queue and are therefore being analyzed for issue. In this scenario, i0 completes in E4 without replaying, i5 and i6 are determined to issue.

In the second cycle, i5 & i6 have advanced from shift queue to D4, i7 and i8 advance direct from D2 to the shift queue (effectively by-passing the pending queue). Note that i7 and i8 must reside in the pointer queue as replay entries, but there is no cycle-penalty involved in placing them there (D2 advancement to shift queue (D3) does not incur a cycle delay penalty —writes to the pointer queue and shift queue occur simultaneously).

Replay

### Replay Activity

The instruction for which replay is asserted is replayed. Alternative schemes replay the instruction following the replayed instruction or the first dependent instruction but these brought no significant performance gains and added considerable complexity.
On replay an instruction is decoded and issued identically with its first issue, however the pipeline, issue-pairing and forwarding can change and, in the case of an unaligned access, the Load-Store unit will generate the required address (by temporarily taking over the AGU)
On replay I-Execute handles all R15 tracking duties. I-Decode does not need to keep any state for PC/R15.
Instructions in the replay queue may be replayed in pairings that differ from those in which they were originally issued. (Bubbles are squashed in the replay queue).
The scoreboard must be cleared on replay. (Instructions behind the replaying instruction have updated the scoreboard with destination register information and these instructions will not complete. Failure to clear the scoreboard would result in erroneously-forwarded source operands).
Replayed instructions must pass though the issue-forwarding logic again to allow forwarding mux controls to be re-evaluated.
An instruction is replayed when its destination register result is unavailable at the expected time. On a load miss, the load instruction itself is replayed not the first instruction dependent on the load data.
Once a replay has started no other replays can occur until the replayed instruction is in E4 i.e. once a replay has started, no other replays can occur until the replay instruction itself has completed. This comes about naturally by signalling all replays from the same pipeline stage (E4). The replayed instruction itself may replay again from E4.
An instruction that causes a replay may also be exceptional in which case the exception will take precedence over the replay.
The replay indicator from LS may be simultaneous with a flush (mispredict/exception) indicator from IX. IX/LS prioritization is such that replay always takes precedence over flush.
On an exception flush, the replay queue, pending queue, and scoreboard are all cleared. I-Decode will start to sequence the exception entry.
Multi-cycle instructions replay from the exact micro-op on which replay fired.

### Replay Entry Sequence

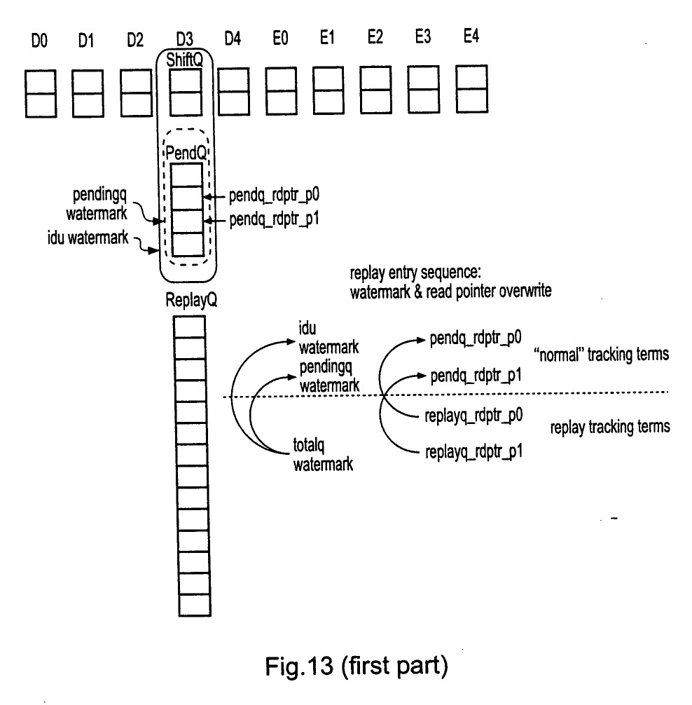

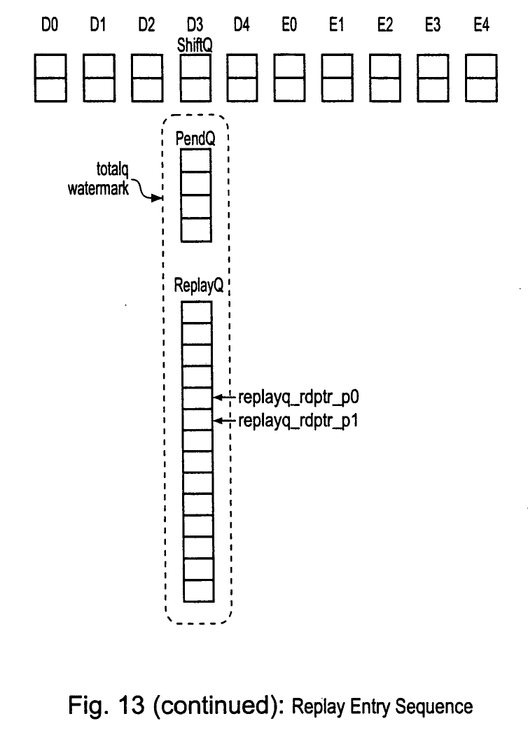

FIG. 13 depicts the watermark and read pointer overwrites that occur as the fundamental activity of the replay entry sequence.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim

1. A data processing apparatus comprising:
a pipelined processor, said pipelined processor comprising an execution pipeline operable to execute instructions in a plurality of execution stages;
a fetch unit for fetching instructions from a memory prior to sending those instructions to said execution pipeline;
an instruction decoder operable to decode said fetched instructions;
instruction evaluation logic operable to evaluate if a decoded instruction has executed as anticipated prior to said decoded instruction passing a replay boundary within said execution pipeline;
a data store operable to store a plurality of decoded instructions in an instruction queue, said data processing apparatus being operable to store a decoded instruction within said instruction queue at least one cycle prior to said decoded instruction entering said execution pipeline and to remove said decoded instruction from said instruction queue upon said decoded instruction passing said replay boundary within said execution pipeline, said instruction queue being arranged such that a next decoded instruction to be read from said instruction queue for execution by said execution pipeline is indicated by a pending pointer value and an instruction being executed in a furthest occupied execution stage of said execution pipeline prior to said replay boundary is indicated by a replay pointer value; wherein
in response to said instruction evaluation logic detecting that said instruction indicated by said replay pointer has not executed as anticipated, said data processing apparatus is operable:
to update said pending pointer value with said replay pointer value;
to flush instructions from said execution pipeline; and
to resume operation such that a next instruction to be read from said instruction queue for execution by said execution pipeline is said decoded instruction indicated by said updated pending pointer value.

2. A data processing apparatus according to claim 1, said data processing apparatus further comprising a data store operable to store a plurality of values comprising at least two of: a total value indicating a total number of decoded instructions stored within said instruction queue, a replay value indicating a number of decoded instructions that have been read from said instruction queue for execution by said execution pipeline and have not passed said replay boundary, and a pending value indicating a number of instructions stored within said instruction queue that have yet to be read from said instruction queue for execution by said execution pipeline; wherein
in response to detection of said instruction indicated by said replay pointer not executing as anticipated, said data processing apparatus is operable to update said at least two stored values, said updated values being such that said pending value and said total value comprise said total value and said replay value comprises zero.

3. A data processing apparatus according to claim 2, said data processing apparatus being operable to control said fetch unit and decoder to stall and not to fetch or decode further instructions upon detection of said pending value being equal to or greater than a predetermined value, and to control said fetch unit and decoder to fetch and decode further instructions upon detection of said pending value being less than said predetermined value.

4. A data processing apparatus according to claim 1, said data processing apparatus further comprising a shift data store operable to store at least one decoded instruction immediately prior to said at least one decoded instruction entering said execution pipeline.

5. A data processing apparatus according to claim 1, said data processing apparatus comprising a decoder having a plurality of decode stages and being operable to load an instruction into said instruction queue from a predetermined decode stage within said decoder.

6. A data processing apparatus according to claim 2, said data processing apparatus being operable on reading of an instruction from said queue for execution by said execution pipeline to update said pointer value to indicate a subsequent instruction, to decrease said pending value by one and to increment said replay value by one.

7. A data processing apparatus according to claim 2, said data processing apparatus being operable when an instruction within said execution pipeline passes said replay boundary, to update said replay pointer to indicate a subsequent instruction and to decrease at least one of said replay value and said total value by one.

8. A data processing apparatus according to claim 2, wherein in response to said pending value being zero, said data processing apparatus is operable to read an instruction for execution by said pipeline from said instruction decoder, to write said instruction to said instruction queue, and to update at least one of said replay value and said total value by incrementing it by one.

9. A data processing apparatus according to claim 1, wherein said instruction evaluation logic is operable to detect that said instruction indicated by said replay pointer has not executed as anticipated when said instruction is executing in an execution stage of said execution pipeline immediately prior to said replay boundary.

10. A data processing apparatus according to claim 1, wherein said instructions fetched from said memory are instructions from within a program sequence and said data processing apparatus is operable to read said decoded instructions from said queue for execution by said execution pipeline in an order of said program sequence.

11. A data processing apparatus according to claim 1, wherein said replay boundary is located at an end of said final execution stage of said execution pipeline.

12. A data processing apparatus according to claim 1, wherein said pipelined processor is a multiple instruction issue pipelined processor comprising multiple parallel execution pipelines, in which:
a next multiple of decoded instructions to be read from said instruction queue for execution by said multiple pipelines are indicated by at least one pending pointer, and wherein said multiple parallel execution pipelines have a hierarchy, such that a first instruction to be read from said queue indicated by a first of said at least one pending pointers is issued to an older of said multiple pipelines and subsequent later instructions are issued to subsequent younger pipelines; and
an instruction being executed in a furthest occupied execution stage before said replay boundary and within an oldest occupied one of said execution pipelines is indicated by a first replay pointer value; wherein
in response to said instruction evaluation logic detecting that one of said instructions executing in an execution stage immediately preceding said replay boundary has not executed as anticipated, said data processing apparatus is operable to update said at least one pending pointer value with a value derived from said replay pointer, said value indicating said instruction that has not executed as anticipated.

13. A data processing apparatus according to claim 12, wherein said queue comprises multiple pending pointers and multiple replay pointers, an instruction indicated by a first of said multiple pending pointers being an instruction to be read from said queue to be executed in an older of said multiple pipelines and subsequent later instructions indicated by subsequent further pending pointers are to be executed in subsequent younger pipelines; and
an instruction being executed in a furthest occupied execution stage before said replay boundary and within an oldest occupied one of said execution pipelines is indicated by a first replay pointer value and subsequent later instructions are indicated by subsequent replay pointers; wherein
in response to said instruction evaluation logic detecting that one of said instructions executing in an execution stage immediately preceding said replay boundary and indicated by one of said replay pointers has not executed as anticipated, said data processing apparatus is operable to update said first pending pointer value with a value of said replay pointer indicating said instruction that has not executed as anticipated and to update said subsequent pending pointers with replay pointer values of replay subsequent to said replay pointers indicating said instruction that has not executed as anticipated.

14. A data processing apparatus to claim 12, wherein
instructions executing in a same stage in parallel pipelines to said instruction indicated by said first replay pointer are indicated by subsequent replay pointers and instructions being executed in a preceding execution stage of said older pipeline and subsequent pipelines are indicated by further subsequent replay pointers.

15. A data processing apparatus according to claim 12, said data processing apparatus further comprising a shift data store operable to store multiple decoded instructions immediately prior to said multiple decoded instructions entering said multiple parallel pipelines.

16. A data processing apparatus according to claim 12, said data processing apparatus being operable on reading of a plurality of instructions from said queue for execution by said multiple execution pipelines to update said pointer value to indicate an instruction subsequent to said last instruction read from said queue and to decrease said pending value by a number of said plurality of instructions read from said queue and to increment said replay value by said number.

17. A data processing apparatus according to claim 12, said data processing apparatus being operable when a plurality of instructions within said multiple execution pipelines pass said replay boundary, to update said replay pointer to indicate an instruction subsequent to said instruction in said youngest pipeline that has just passed said replay boundary and to decrease said replay value by a number of said plurality of instructions that have just passed said replay boundary.

18. A data processing apparatus according to claim 12, wherein in response to said pending value being smaller than said number of parallel execution pipelines, said data processing apparatus is operable to read at least one of said instructions for execution by said pipelines from said instruction decoder and to write said at least one instruction to said instruction queue, and to update at least one of said replay value and said total value by incrementing it by at least one.

19. A method of processing data comprising:
fetching instructions from a memory prior to sending said fetched instructions to an execution pipeline having a plurality of execution stages for execution;
decoding said fetched instructions;
storing a decoded instruction in an instruction queue at least one cycle prior to said decoded instruction being loaded into said execution pipeline, said instruction queue being arranged such that a next decoded instruction to be read from said instruction queue for execution by said execution pipeline is indicated by a pending pointer value and an instruction being executed in a furthest occupied execution stage of said execution pipeline prior to a replay boundary is indicated by a replay pointer value;
reading said instruction indicated by said pending pointer from said instruction queue for execution by said execution pipeline processor;
removing a decoded instruction from said instruction queue upon said decoded instruction passing said replay boundary within said execution pipeline; and wherein
prior to said instruction indicated by said replay pointer passing said replay boundary, evaluating whether said instruction has executed as anticipated and in response to detection of said instruction not having executed as anticipated;
updating said pending pointer value with said replay pointer value;
flushing instructions from said execution pipeline;
resuming operation such that a next instruction to be read from said instruction queue for execution by said execution pipeline is said decoded instruction indicated by said updated pending pointer value.

20. A method of processing data according to claim 19, said method further comprising:
storing a plurality of values in a data store, said plurality of values comprising a total value indicating a total number of decoded instructions stored within said instruction queue, a replay value indicating a number of decoded instructions stored within said instruction queue that have been read from said instruction queue for execution by said execution pipeline and have not passed said replay boundary, and a pending value indicating a number of instructions stored within said instruction queue that have yet to be read from said instruction queue for execution by said execution pipeline; wherein
in response to detection of said instruction indicated by said replay pointer not executing as anticipated, updating at least two of said total value, said pending value and said replay value, with updated values such that said pending and total value comprise said total value and said replay value comprises zero prior to resuming operation.

21. A means for processing data comprising:
a pipeline processing means comprising an execution pipeline means for executing instructions in a plurality of execution stages;
a fetch means for fetching instructions from a memory prior to sending those instructions to said execution pipeline;
an instruction decoding means for decoding said fetched instructions;
instruction evaluation means for evaluating if a decoded instruction has executed as anticipated prior to said decoded instruction passing a replay boundary within said execution pipeline means;
means for storing a plurality of decoded instructions in an instruction queue, said means for processing data being operable to store a decoded instruction within said instruction queue at least one cycle prior to said decoded instruction entering said execution pipeline means and to remove said decoded instruction from said instruction queue upon said decoded instruction passing said replay boundary within said execution pipeline means, said instruction queue being arranged such that a next decoded instruction to be read from said instruction queue for execution by said execution pipeline means is indicated by a pending pointer value and an instruction being executed in a furthest occupied execution stage of said execution pipeline prior to said replay boundary is indicated by a replay pointer value; wherein
in response to said instruction evaluation means detecting that said instruction indicated by said replay pointer has not executed as anticipated, said means for processing data is operable:
to update said pending pointer value with said replay pointer value;
to flush instructions from said execution pipeline means; and
to resume operation such that a next instruction to be read from said instruction queue for execution by said execution pipeline means is said decoded instruction indicated by said updated pending pointer value.
